(19) United States
(12) Patent Application Publication
(10) Pub. No.: US 2002/0055432 A1
(43) Pub. Date: May 9, 2002

(54) Photocatalyst and method for producing the same

(76) Inventors: Keiichi Tanaka, Oita-shi (JP); Muhammad Shariq Vohra, Nepean (CA)

Correspondence Address: BIRCH STEWART KOLASCH & BIRCH, PO BOX 747, FALLS CHURCH, VA, 22040-0747, US

(21) Appl. No.: 09/986,429

(22) Filed: Nov. 8, 2001

(30) Foreign Application Priority Data
Nov. 8, 2000 (JP) 2000-340897

(51) Int. Cl. B01J 21/06

(52) U.S. Cl. 502/208; 502/343; 502/350; 502/242

(57) ABSTRACT

A photocatalyst, which has an opposite electric charge to a substances to be treated, in which the opposite electric charge is given by carrying an inorganic substance on a surface of the photocatalyst. A method for producing the photocatalyst.

### FIELD OF THE INVENTION

The present invention relates to a photocatalyst that can be used in treatment, such as decomposing or removeing of harmful substances. The present invention also relates to a method for producing the photocatalyst to be used for the treatment.

### BACKGROUND OF THE INVENTION

While various techniques have been developed for treatment of wastewater and polluted air by a photocatalyst, the efficiency of treatment is still inefficient so that application of the photocatalyst at practical levels is limited. Carrying platinum on a photocatalyst or doping impurities in a photocatalyst, is conducted to improve the efficiency of the photocatalyst, but these are not satisfactory in efficiency considering its high producing cost. In addition, the effect is different depending on the kind of the photocatalyst in the former case, while a stable result cannot be obtained in the latter case, which are problems.

### SUMMARY OF THE INVENTION

The present invention is a photocatalyst that has an opposite electric charge to a substance to be treated, in which the opposite electric charge is given by carrying an inorganic substance on a surface of the photocatalyst.

Further, the present invention is a method for producing a photocatalyst, which comprises bringing to exist, partially and uniformly, on a surface of a photocatalyst, an inorganic substance having an opposite electric charge to a substance to be treated.

Other and further features and advantages of the invention will appear more fully from the following, description.

### DETAILED DESCRIPTION OF THE INVENTION

The inventors of the present invention, studying earnestly to solve the above problems in the conventional methods, have found that, by allowing a photocatalyst to have an electric charge originating from an inorganic substance, harmful substances having an opposite electric charge are collected on the surface of the photocatalyst and are efficiently decomposed. The present invention has been attained based on this finding. Specifically, we have found that the photocatalyst exhibits high photocatalyst-activity against electrically-charged harmful substances, for example, by allowing an inorganic anion-exchange substance, which is not by itself decomposed by the photocatalyst, to be partially carried on the surface of the photocatalyst.

According to the present invention there are provided the following means:

(1) A photocatalyst, having an opposite electric charge to a substance to be treated, in which the opposite electric charge is given by carrying an inorganic substance on a surface of the photocatalyst;

(2) The photocatalyst according to item (1), comprising the photocatalyst, and an ion-exchange substance carried on the photocatalyst and having the opposite electric charge to the substance to be treated; and

(3) A method for producing a photocatalyst, comprising bringing an inorganic substance having an opposite electric charge to a substance to be treated, to exist partially and uniformly on a surface of a photocatalyst.

The photocatalyst of the present invention can collect harmful substances having an oppsosite electric charge dispersed in water or air, onto the photocatalyst surface, to decompose the harmful substances at a neighboring active site of the photocatalyst in good efficiency; that is, the photocatalyst of the present invention is “highly-active.”

There is no particular restriction on the photocatalyst to be used as a main material in the present invention. Any material that can be usually used as a photocatalyst may be used for the photocatalyst according to the present invention. Examples of the photocatalyst include titanium dioxide, zinc oxide, zirconium oxide and tungsten oxide; and among these, titanium dioxide is preferably used.

The photocatalyst may be used in a form of a powder, or a powder immobilized on various supports (bases), or a film that is prepared by a sol-gel method or deposition method.

A substance having an electric charge opposite to the target substance to which catalytic action is worked (hereinafter referred to simply as an opposite electric charge substance) is carried on the photocatalyst.

Examples of the opposite electric charge substance include hydroxides or phosphates of silicon, aluminum or zirconium; and among these, silicon or zirconium compounds are preferable. Among the silicon or zirconium compounds, specifically ion exchange substances are preferable, and cation exchange substances are particularly preferable to be used when the harmful substance in the substances to be treated has a positive electric charge. It is important to finely disperse the cation exchange substance for allowing it to be carried on the photocatalyst, thereby allowing to enhance the probability of the resultantly-adsorbed substance to be treated, to contact with the exposed surface of the photocatalyst, titanium dioxide.

Examples of the cation exchange substance include silicon dioxide (silica), alumina and zirconium phosphate. Silica may be prepared in a usual manner such as heating of sodium silicate or potassium silicate. The amount of the cation exchange substance to be carried may be appropriately determined without any restrictions, and, for example, the amount to be used of the silicon compound as a starting material is generally 0.005 to 1.0 g, particularly preferably 0.05 to 0.5 g, in terms of SiO₂, to 1 g of the photocatalyst. The similar amount is applicable to other cation exchange substances.

In the method for producing the photocatalyst according to the present invention is explained below, referring to an example in which the silicon compound is used. The above-described photocatalyst, and a solution of a silicon compound are uniformly mixed, stirred, followed by drying and sintering at a temperature of 400° C., to convert the silicon compound into silicon oxide (silica). The amount of water is important when the solution of the silicon compound is an aqueous solution. The photocatalyst and the silicon compound cannot be uniformly dispersed when the amount of water is too small, while the mixture will be nonuniform during the drying step when the amount of water is too large. The resultant powder of titanium dioxide that carries silica thereon may be immobilized on a support using a binder.

For carrying the silicon compound on the photocatalyst, a small amount of solvent can be added little by little, after thoroughly mixing a high concentration solution of the silicon compound with the photocatalyst, to enhance mixing (and for entirely and uniformly dispersing the silicon compound into the photocatalyst), thereby avoiding ununiform mixing that may occur before evaporation of the solvent. The function of the photocatalyst may be damaged by covering the entire surface of the photocatalyst when the amount of the silicon compound is too large. A high activity cannot be obtained when mixing is ununiform, probably because particles most of the surface of which is covered and particles with insufficient carrying of the silicon compound exist together. It is preferable to exist the opposite electric charge substance on the photocatalyst as uniform as possible, for expressing the activity of the photocatalyst. The surface covering ratio of the opposite electric charge substance may be determined to its optimum by measuring the activity of the photocatalyst. Generally, preferably 30% or less, more preferably 10 to 30% of the surface area of the photocatalyst is covered with the opposite electric charge substance, but the ratio is not restricted to the above.

The photocatalyst of the present invention obtained by using the above silicon compound or the like, is anionic, and it is effective for the cationic harmful substances. For example, the photocatalyst is effective against primary to quaternary amine (ammonium) compounds and pyridine (pyridinium) compounds, and salts thereof.

For treating the harmful substance in water using the photocatalyst of the present invention, wastewater is made to contact Edith the photocatalyst, while irradiating with an ultraviolet light.

A light source containing a short-wavelength light of less than 380 nm is generally used as the irradiation light source. Examples thereof include a high-pressure or low-pressure mercury-vapor lamp, xenon lamp, halogen lamp, black light and sunlight.

The photocatalyst of the present invention is highly active, it is excellent in decomposition efficiency of harmful substance, and it exhibits a stable activity for a long period of time. According to the method for producing the photocatalyst according to the present invention, such an excellent photocatalyst as described herein can be produced efficiently at a low cost.

The present invention will be described in more detail based on the following examples, but the invention is not meant to be limited by these.

### EXAMPLES

### Example 1

Four grams of titanium dioxide (ananase) was added to 4 ml of potassium silicate (18 to 21% solution in terms of SiO₂), followed by mixing well. Thereto, was added a small volume of water, followed by mixing. This process was repeated in the range not to increase the total volume of water above 3.25 ml. The resultant mixture was dried at 100° C. for 1 hour, followed by sintering at 400° C. for 1 hour. The sintered material was crushed in a mortar, after cooling to room temperature. The resultant powder was repeatedly washed with water until pH of the resultant suspension became 7. By drying the resultant suspension at 100° C., a photocatalyst that carried silica thereon was finally obtained.

Then, 2 g of the thus-prepared titanium dioxide carrying silica thereon was suspended in 500 ml of an aqueous solution of 2.5×10⁻⁵ M paraquat, in a cylindrical glass vessel. The vessel was irradiated with 6W black light placed at the center of the vessel. All of the paraquat in the suspension was decomposed within 5 minutes. Then, light irradiation was continued for additional 3 hours. After recovering the photocatalyst, the irradiation experiment was carried out in the same manner as above. As a result, all of the paraquat was decomposed by irradiation within 15 minutes. The above procedure was carried out repeatedly four times, and paraquat was decomposed within 15 minutes in all the cases.

For comparison, the above experiment was carried out in the same manner, except that titanium dioxide without carrying silica was used in place of the photocatalyst, titanium dioxide carrying silica thereon. As a result, 70 minutes of irradiation was necessary for decomposing all the paraquat in the sample.

### Example 2

The photocatalyst carrying silica thereon was prepared in the same manner as in Example 1, except that 0.2 ml of potassium silicate was added, in place of adding 4 ml of potassium silicate as in Example 1. Paraquat was decomposed using the photocatalyst prepared as described above, in the same manner as in Example 1. All paraquat was decomposed by 20 minutes irradiation.

### Example 3

The experiment was carried out in the same manner as in Example 1 using the photocatalyst as prepared in Example 1,except that 10 M of ethylamine was used in place of paraquat. The photocatalyst was recovered to carry out the experiment up to three times in the same manner, resulting in decomposition of all ethylamine within 50 minutes in all the three times of the experiments. On the contrary, the above experiment was carried out in the same manner, except that titanium dioxide without carrying silica was used, in place of the photocatalyst that carried silica thereon. As a result, 160 minutes of irradiation was necessary for decomposing all the paraquat in the sample.

### Example 4

Added was 40% by mass of hydrogen fluoride (4 ml), to 5.5 g of zirconium oxychloride (ZrCl₂O·/8H₂O), 80 ml of water and 5.5 g of titanium dioxide, while stirring, followed by adding 85% by mass of phosphoric acid (46 ml). After stirring for 1 hour, the resultant solution was left to stand to remove the supernatant. Then, after adding additional water thereto, the above procedure was repeated several times. The resultant titanium dicide that carried zirconium phosphate thereon was washed with water, and dried at 100° C.

The thus-prepared titanium dioxide carrying zirconium phosphate (75 mg) was suspended in a 2.5×10⁻⁴ M paraquat solution (25 ml), and the resultant suspension was irradiated with a 500-W ultrahigh-pressure mercury-vapor lamp, through a filter of heat-resisting glass (Pyrex glass, trade name) and water. Paraquat was decomposed within 20 minutes at the decomposition ratio of 100%. The titanium dioxide was recovered, to repeat the same experiments four times. Paraquat was also decomposed in each experiment by 20 minutes, irradiation at the decomposition ratio of 100%.

On the contrary, when using titanium dioxide carrying no zirconium phosphate, in place of the above photocatalyst, paraquat was decomposed only at the decomposition ratio of 82%, even by 60 minutes irradiation.

### Comparative Example 1

Decomposition of 2×10⁻⁵ M of acetic acid and phenol was tested, using the photocatalyst as prepared in Example 1. The above experiment was carried out in the same manner, except for using titanium dioxide not carrying silica thereon, in place of the photocatalyst. As a result, carrying of silica was not effective for both the compounds to decompose. This result indicates that the photocatalyst of the present invention is effective against cationic compounds, while carrying of silica has no effect in decomposition of anionic or neutral compounds.

Having described our invention as related to the present embodiments, it is our intention that the invention not be limited by any of the details of the description, unless otherwise specified, but rather be construed broadly within its spirit and scope as set out in the accompanying claims.

What we claim is:

1. A photocatalyst, having an opposite electric charge to a substances to be treated, in which the opposite electric charge is given by carrying an inorganic substance on a surface of the photocatalyst.

2. The photocatalyst according to claim 1, comprising the photocatalyst, and an ion-exchange substance carried on the photocatalyst and having the opposite electric charge to the substance to be treated.

3. The photocatalyst according to claim 1, wherein the ion-exchange substance is at lease one cation exchange substance selected from the group consisting of silicon dioxide, alumina and zirconium phosphate.

4. The photocatalyst according to claim 1, wherein the photocatalyst is at lease one selected from the group consisting of titanium dioxide, zinc oxide, zirconium oxide and tungsten oxide.

5. The photocatalyst according to claim 1, wherein the photocatalyst is titanium dioxide.

6. A method for producing a photocatalyst, comprising bringing an inorganic substance having an opposite electric charge to a substance to be treated, to exist partially and uniformly on a surface of a photocatalyst.

7. The method according to claim 6, comprising the steps of:
mixing the inorganic substance and the photocatalyst well;
adding thereto a small amount of a solvent little by little, to mix; and
evaporating the solvent, thereby bringing the inorganic substance to exist partially and uniformly on the photocatalyst surface.
